(19) United States
(12) Patent Application Publication
(10) Pub. No.: US 2023/0394538 A1
(43) Pub. Date: Dec. 7, 2023

(54) METHODS AND SYSTEMS FOR THE DECENTRALIZATION OF CRYPTOGRAPHICALLY SECURED INSTRUMENTS

(71) Applicant: SIMBA Chain, Inc., South Bend, IN (US)

(72) Inventors: Joseph A. Grundfest, South Bend, IN (US); Bryan Ritchie, South Bend, IN (US); Ian Taylor, South Bend, IN (US); Simon Grunfeld, South Bend, IN (US); Matthew Welz, South Bend, IN (US); Kirsten Stor, South Bend, IN (US)

(21) Appl. No.: 18/329,264

(22) Filed: Jun. 5, 2023

Related U.S. Application Data
(60) Provisional application No. 63/348,699, filed on Jun. 3, 2022.

(51) Int. Cl. G06Q 30/0283; G06Q 50/18

(52) U.S. Cl. CPC G06Q 30/0283; G06Q 50/184; G06Q 2220/18

(57) ABSTRACT

Methods, systems, and apparatuses are described that are configured for dynamically adjusting the governance structure for cryptographically secured instruments. One or more parameters associated with an indication of an ownership of at least one digital asset of a plurality of assets. An attribute associated with each digital asset maybe adjusted based on the one or more parameters associated with the at least one indication of the ownership of the at least one digital asset of the plurality of digital assets.

### CROSS REFERENCE TO RELATED PATENT APPLICATION

This application claims priority to U.S. Provisional Application No. 63/348,699, filed Jun. 3, 2022, which is herein incorporated by reference in its entirety.

### BACKGROUND

The separation of governance rights from economic interests is common in modern capital markets. Non-voting and super-voting shares are examples of this phenomenon. These existing capital market structures are not, however, dynamically adjustable in a manner that is contingent on the distribution of governance power at the time voting or other governance rights are to be exercised. Put another way, the number of votes held by person A is generally not contingent on the number of votes held by person B, nor is that relationship generally adjusted over time in response to exogenous factors.

Demand for a mechanism in which governance rights can be disassociated from economic interests in a manner that redistributes governance authority so as to create greater, or lesser, equality among participants' voting or other governance rights arises, in part, because of the Securities and Exchange Commission's reliance on the concept of “decentralization” as part of its assessment of whether an instrument qualifies as a security and must therefore be registered as such with the Commission. As a practical matter, if an investment is not sufficiently decentralized, and must register and trade as a security, it can be functionally non-tradable and illegal in U.S. markets. Satisfying the decentralization test can therefore be essential to the legal creation of cryptographically secured investments (such as NFT's, or fungible forms of crypto, such as ADA) and the legal after-market trading of those instruments in the United States.

However, the Commission has failed to provide guidance as to the definition of “centralization” or as to the distribution of governance rights that would or would not qualify as sufficiently decentralized under federal securities law. Creators of cryptographically secured instruments thus often guess at the distributions of governance rights that might support a conclusion of sufficient decentralization, and they engage in various forms of non-standard activity, such as air drops, in an effort to achieve some level of decentralization that they hope will be sufficient.

Furthermore, these cryptocurrencies are assumed to be completely decentralized due to the nature of the “immutable ledger” used as a record of all the transactions involving the cryptocurrency. Cryptocurrency “coins,” or income, may be earned through the method of “mining” for the coins, such as in the case of Bitcoin. Miners (e.g., people who mine for these coins) use their computational resources to solve complex math equations in order to earn the right to add new blocks to the blockchain. When a miner is successful, he or she can earn cryptocurrency income. Moreover, the payout rate usually decreases over time, dropping in half roughly every few years. Studies have shown that the control of these cryptocurrencies are not always decentralized, especially in the early stages of the cryptocurrency's release. For example, these studies have shown that only a concentrated group of people, such as a group of miners, tend to accumulate the majority of the cryptocurrency during the early stages of the cryptocurrency's release. In a few months of a cryptocurrency's introduction, a classic distribution of income inequality tends to emerge, wherein only a small fraction of miners hold most of the wealth and power. A small group of miners usually becomes more successful than others, and thus, leads to the income disparity wherein only a few of the miners control the majority of the resources associated with the cryptocurrency. In other words, although the cryptocurrency is considered to be a decentralized instrument, it is susceptible to being controlled by a centralized group of people.

Another study has shown that the concentration of resources threatened the network's security, with a miner's computational resources being proportionate to his or her mining income. On several occasions, individual miners wielded more than 50 percent of the computational power and, as a result, could have taken over, like a tyrant, using what's called a “51 percent attack.” For example, he or she could have cheated the system and repeatedly spent the same cryptocurrency coin on different transactions. He or she would essentially be able to prevent new transactions from gaining confirmations, allowing them to halt payments between some or all users. In addition, he or she would be able to reverse transactions that were completed while they were in control of the network. A forced decentralization of the cryptocurrency could drastically reduce the possibility of a 51 percent attack on the cryptocurrency.

### SUMMARY

It is to be understood that both the following general description and the following detailed description are exemplary and explanatory only and are not restrictive. Methods, systems, and apparatuses for improved decentralization of cryptographically secured instruments are described.

In an embodiment are methods comprising determining, by a computing device, a plurality of digital assets, determining one or more parameters associated with at least one indication of an ownership of at least one digital asset of the plurality of digital assets, and adjusting, based on the one or more parameters associated with the at least one indication of the ownership of the at least one digital asset of the plurality of digital assets, an attribute associated with each digital asset of the plurality of digital assets.

In an embodiment are methods comprising determining, by a computing device, based on a trigger, one or more parameters associated with at least one indication of an ownership of at least one digital asset of a plurality of digital assets, determining, based on the one or more parameters associated with the at least one indication of the ownership of the at least one digital asset of the plurality of digital assets, a measure of decentralization, refraining from adjusting, based on the measure of decentralization satisfying a threshold, an attribute associated with at least one digital asset of the plurality of digital assets, and sending a notification comprising an indication of the measure of decentralization satisfying the threshold.

In an embodiment are methods comprising determining, by a computing device, based on a trigger, one or more parameters associated with at least one indication of an ownership of at least one digital asset of a plurality of digital assets, determining, based on the one or more parameters associated with the at least one indication of the ownership of the at least one digital asset of the plurality of digital assets, a measure of decentralization, and adjusting, based on the measure of decentralization not satisfying a threshold, an attribute associated with at least one digital asset of the plurality of digital assets.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example system for adjusting an attribute associated with a digital asset;

FIG. 2 shows an example blockchain system;

FIG. 3 shows example user wallets;

FIG. 4 shows an example blockchain network environment;

FIG. 5 shows a flowchart of an example method;

FIG. 6 shows a flowchart of an example method;

FIG. 7 shows a flowchart of an example method; and

FIG. 8A-8C show example data associated with the digital asset.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

“Hashes” (also referred to herein as “hash functions,” “cryptographic hash functions,” and the like) include functions that map an initial input data set to an output data set. The output from a hash function may be referred to herein as a “hash identifier,” “hash value,” “hash data set,” or simply, a “hash”). Generally, the output values from a given hash function have the same fixed length. Generally, if the same hash function is used on the same input data it will result in the same output data value. With some hash functions (including those used in the context of blockchain techniques and/or the subject matter of this application) the input value is computationally difficult to determine when only the output value is known. In certain examples, the input value for the hash function is supplemented with some additional random data. For example, an input value of “blockchain” for a hash function may include additional random data such as three random characters. Accordingly, the data value that is hashed may be “blockchaina7h” instead of simply “blockchain.” The additional random data is sometimes called a “nonce.”

As used herein, the terms “digital asset,” “token asset,” or “token” may indicate a digital currency or a cryptocurrency, such as Simba coin, Bitcoin, Litecoin, TorCoin, Ethereum, etc.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user,” or “individual,” may indicate a person who uses an electronic device or digital wallet.

A dynamically adjustable governance structure with applications to cryptographically secured instruments is described. Based on a trigger, a digital asset may be received by a computing device, or by a user's digital wallet. The trigger, or event, may comprise at least one of a distribution of the digital asset, a time period before the distribution of the digital asset, a time period after the distribution of the digital asset, or a transaction of the digital asset between two or more digital wallets. Each digital wallet may comprise a wallet address, wherein the wallet address may comprise a unique identifier configured for sending and receiving a digital asset. Each digital asset may be associated with at least one attribute such as a voting right, a monetary value, an ability to distribute the digital asset, whitelisting wallet addresses, blacklisting wallet addresses, staking, or combinations thereof. A record indicating the digital asset received by the digital wallet may be stored in a database, or a blockchain. The blockchain may comprise an indication of a total amount of the digital assets held by one or more individuals or digital wallets and an indication of other digital assets held by the one or more individuals or digital wallets. Based on one or more parameters associated with at least one indication of an ownership of at least one digital asset of the plurality of digital assets, the attribute associated with each digital asset may be adjusted.

In an example, the one or more parameters may comprise one or more of a number of digital assets owned or controlled, a period of time for which at least one digital asset of the plurality of digital assets is owned or controlled, an entity from which at least one digital asset of the plurality of digital assets is acquired, a method by which at least one digital asset of the plurality of digital assets is acquired, or a price paid for at least one digital asset of the plurality of digital assets. The entity may comprise one or more of an individual, a person, a governmental entity, a distributor of the digital asset, or a wallet address.

In an example, the at least one indication of the ownership of the at least one digital asset of the plurality of digital assets may comprise one or more of an individual associated with the at least one digital asset of the plurality of digital assets, a person associated with the at least one digital asset of the plurality of digital assets, an organization associated with the at least one digital asset of the plurality of digital assets, or a wallet address associated with the at least one digital asset of the plurality of digital assets.

In an example, the voting rights associated with the digital asset may be adjusted. In an example, the voting rights may remain the same based on a parameter with associated with each digital asset of the plurality of digital assets satisfying a threshold. In an example, the voting rights may be decreased, or increased, based on a parameter associated with each digital asset of the plurality of digital assets not satisfying a threshold. The threshold may be based on a measure of decentralization. For example, the measure of decentralization may comprise one or more of a Gini index, a Nakamoto index, a Shapley-Shubik power index, a Banzhaf power index, or combinations thereof. In an example, other government rights associated with the digital asset may be adjusted such as voting rights, monetary value, the ability to acquire the digital asset, the ability to distribute the digital asset, or the whitelisting or blacklisting of wallet addresses.

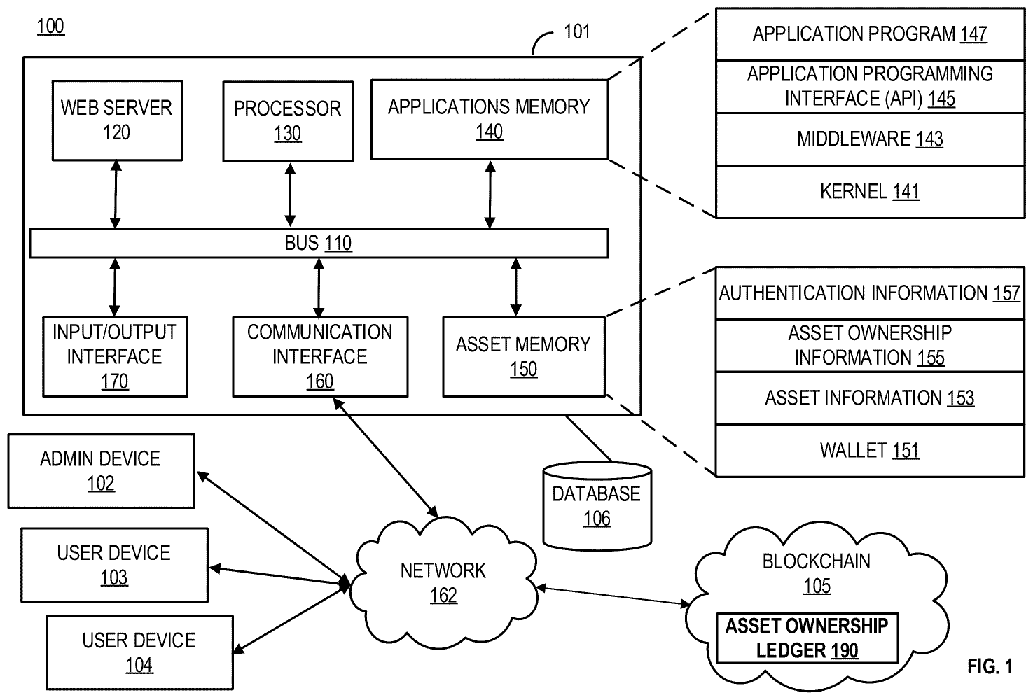

FIG. 1 shows an example system 100 including a server computing device 101 for implementing the cryptographically secured instrument system in a distributed manner using one or more blockchains for performing applications utilizing the recorded ownership of the digital assets. The system 100 may include a blockchain system 105 for storing one or more ledgers related to one or more asset types (e.g., a digital asset), a server computing system 101 for performing operations utilizing the one or more ledgers, and one or more user devices 102-104 for accessing services provided by the server computing system 101. The blockchain system 105, server computing device 101, and the user devices 102-104 may be interconnected by a network 162. The network environment 100 may also include one or more databases 106 providing access to various data and/or processing by third party systems. The databases 106 may be connected to the server computing system 101 directly or indirectly through network 162.

The server computing device 101 may include a bus 110, a webserver 120, a processor 130, an application memory 140, an asset memory 150, a communication interface 160, and an input/output interface 170. In an example, the server computing device 101 may omit at least one of the aforementioned constitutional elements or may additionally include other constitutional elements. In an example, the server computing device 101 may include a plurality of servers.

The bus 110 may include a circuit for connecting the bus 110, the webserver 120, the processor 130, the application memory 140, the asset memory 150, the communication interface 160, and the input/output interface 170 to each other and for delivering communication (e.g., a control message and/or data) between the bus 110, the webserver 120, the processor 130, the application memory 140, the asset memory 150, the communication interface 160, and the input/output interface 170.

Web server 120 may include one or more web servers and/or other servers, such as, but not limited to, application servers, load balancing servers, etc., and operates to receive inputs from operators including administrators and users of the server computer device 101. Web server 120, in response to inputs received from an operator or in response to internally-generated signals, may perform or cause the server computer device 101 to perform operations for maintaining records of asset ownership in an immutable manner using a blockchain, and/or for providing services utilizing immutable records of asset ownership in a blockchain.

The processor 130 may include one or more of a Central Processing Unit (CPU), an Application Processor (AP), and a Communication Processor (CP). The processor 130 may control, for example, at least one of the bus 110, the webserver 120, the processor 130, the application memory 140, the asset memory 150, the communication interface 160, and the input/output interface 170 of the server computing device 101 and/or may execute an arithmetic operation or data processing for communication. The processing (or controlling) operation of the processor 130 according to various embodiments is described in detail with reference to the following drawings.

Processor-executable instructions executed by the processor may be stored and/or maintained by the applications memory 140. The applications memory 140 may include a volatile and/or non-volatile memory. The applications memory 140 may comprise random-access memory (RAM), flash memory, solid state or inertial disks, or any combination thereof. The applications memory 140 may store, for example, a command or data related to at least one of the bus 110, the webserver 120, the processor 130, the asset memory 150, the communication interface 160, and the input/output interface 170 of the server computing device 101. As an example, the applications memory 140 may store a software and/or a program. The program may include, for example, a kernel 141, a middleware 143, an Application Programming Interface (API) 145, and/or an application program (or an “application”) 147, or the like, configured for controlling one or more functions of the server computing device 101 and/or an external device. At least one part of the kernel 141, middleware 143, or API 145 may be referred to as an Operating System (OS). The applications memory 140 may include a computer-readable recording medium having a program recorded therein to perform the method according to various embodiment by the processor 130.

The kernel 141 may control or manage, for example, system resources (e.g., the bus 110, the processor 130, the applications memory 140, etc.) used to execute an operation or function implemented in other programs (e.g., the middleware 143, the API 145, or the application program 147). Further, the kernel 141 may provide an interface capable of controlling or managing the system resources by accessing individual constitutional elements of the server computing device 101 in the middleware 143, the API 145, or the application program 147.

The middleware 143 may perform, for example, a mediation role so that the API 145 or the application program 147 can communicate with the kernel 141 to exchange data.

Further, the middleware 143 may handle one or more task requests received from the application program 147 according to a priority. For example, the middleware 143 may assign a priority of using the system resources (e.g., the bus 110, the processor 130, or the applications memory 140) of the server computing system 101 to at least one of the application programs 147. For example, the middleware 143 may process the one or more task requests according to the priority assigned to the at least one of the application programs, and thus may perform scheduling or load balancing on the one or more task requests.

The API 145 may include at least one interface or function (e.g., instruction), for example, for file control, window control, video processing, or character control, as an interface capable of controlling a function provided by the application 147 in the kernel 141 or the middleware 143.

The server computing device 101 may further include asset memory 150. Asset memory 150 may include wallet memory 151 and, optionally, one or more other storage memories including asset information 153, asset ownership information 155, and authentication information 157. As an example, the asset memory 150 may be included within the same memory unit/device as the applications memory 140.

Similar to the applications memory 140, the asset memory 150 may include a volatile and/or non-volatile memory. In an example, the asset memory 150 may include data structures or other logical structures used to store associated data on one or more common or dedicate electronic data storage (e.g., RAM, FLASH memory, or a hard-drive). In an example, dedicated hardware devices, such as a hardware security module (HSM), may be used to store information associated with the asset memory 150. In an example, the asset memory 150 may be stored on a dedicated storage hardware externally provided and in communication with the server computing device 101, including the database 106.

Wallet memory 151 may store a “digital wallet” for each of one or more individuals who have at least temporary ownership of a digital asset stored on the blockchain, in order for that individual to access the server computer device 101 and the blockchain system 105. A digital wallet may enable the “owner” of that digital wallet to interact with the blockchain system 105. In an example, a single digital wallet may be associated with multiple beneficial owners. In an example, each digital asset may be configured to indicate an ownership of the digital asset. Each digital wallet may comprise a wallet address, wherein the wallet address may comprise a unique identifier configured for sending and receiving a digital asset. The “owner” of a digital wallet may be an administrative user for the server computer device 101, an administrative user for an entity, or an end-user of an application utilizing the blockchain system. For example, wallet memory 151 may include a digital wallet for an individual of user device (e.g., user device 103, user device 104, etc.) by which that individual can record information (e.g., by submitting a transaction) to the blockchain, for example, to a ledger of records of asset ownership 190, cause processing using information accessed from the blockchain, and enable other participants in the system to send transactions to that individual. In an example, one or more of the user devices (e.g., user device 103, user device 104, etc.) may store at least a part of the digital wallet for that individual.

Asset information memory 153 may store information regarding assets related to operations performed by the server computing device 101 while utilizing the blockchain system 105. For example, asset information memory 153 may store the name of each digital asset (e.g., shares of particular type), issuer information, total issued number of the digital asset, total votes associated with the digital asset, etc., for which ownership is recorded in the blockchain.

Asset ownership information memory 155 may include asset ownership information. For example, for a plurality of digital assets indicated in the asset information 153, asset ownership information memory 155 may store ownership information. In an example, asset ownership information memory 155 may include a copy of asset ownership information recorded in the blockchain.

Authentication information memory 157 may store information for authenticating the users of the system. The users of the system may be owners of digital assets recorded in memories 153 and/or 155, proxies for digital asset owners, etc.

The communication interface 160 may establish, for example, communication between the server computing device 101 and the external devices (e.g., a user devices 102-104). For example, the communication interface 160 may communicate with the external device (e.g., a user devices 102-104) by being connected to a network 162 through wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. The wired communication may include, for example, at least one of Universal Serial Bus (USB), High Definition Multimedia Interface (HDMI), Recommended Standard-232 (RS-232), power-line communication, Plain Old Telephone Service (POTS), and the like. The network 162 may include, for example, at least one of a telecommunications network, a computer network (e.g., LAN or WAN), the internet, and a telephone network.

The input/output interface 170 may comprise an interface for delivering an instruction or data input from a user or a different external device(s) to the different constitutional elements of the server computing device 101. Further, the input/output interface 170 may output an instruction or data received from the different constitutional element(s) of the server computing device 101 to the different external device. In an example, the input/output interface 170 may be a web-based interface which enables an administrator or other operator to access information stored on the blockchain and/or to store information on the blockchain. The input/output interface 170 may include a client-based part which executes on the access device (e.g., admin device 102, user device 103, user device 104) being used by an administrator or other operator, and a server part which may be performed by the web server 134. The input/output interface 170 may include a web-based or app-based graphical user interface (GUI) for creating and managing accounts, administering/adjusting voting rights, etc.

In an example, the server computing device 101 may include a group of one or more servers. For example, all or some of the operations executed by the server computing device 101 may be executed in a different one or a plurality of electronic devices (e.g., the admin device 102, the user device 103, or the user device 104). As an example, if the server computing device 101 needs to perform a certain function or service either automatically or based on a request, the server computing device 101 may request at least some parts of functions related thereto alternatively or additionally to a different electronic device (e.g., the admin device 102, the user device 103, or the user device 104) instead of executing the function or the service autonomously. The different electronic devices (e.g., the admin device 102, the user device 103, or the user device 104) may execute the requested function or additional function, and may deliver a result thereof to the server computing device 101. The server computing device 101 may provide the requested function or service either directly or by additionally processing the received result. For this, for example, a cloud computing, distributed computing, or client-server computing technique may be used.

In an example, the server computing device 101 may initiate the initial distribution of the digital asset. A specific number of digital assets may be released, wherein the number of digital assets may depend on the type of activity. For example, the initial distribution of the digital asset may be 30% of the digital asset to the Treasury to be distributed as needed to decentralize the network and incentivize participation. The maximum percentage remaining (up to 70%) that will not cause the chosen decentralization measure to exceed the predetermined limit may be given to the entity performing the distribution of the digital asset. Any distribution of digital assets that may cause the centralization measure to exceed the appropriate chosen coefficient may be distributed equally to the digital asset holders that make up the bottom 5% with respect to total holdings. The initial digital asset distribution may be based on a network initiated digital asset minting process, which requires input into the network, in order to initiate a minting request. The minting request may be rolled up daily (at maximum) in order to maintain low resource requirements.

Each digital asset may be given a default voting value, such as an initial voting value of 1 (e.g., one digital asset, one vote). If the algorithm is invoked (e.g., based on a “Simba coefficient” or a Gini index), the votes may be reduced from concentrated holders or added to smaller holders, or both, to reduce the coefficient. In an example, each digital asset may be configured to indicate ownership information of that digital asset. For example, a digital asset belonging to an Individual A, may be configured, or encoded, with information indicating that Individual A owns that particular digital asset.

In an example, the server computing device 101 may adjust the voting rights associated with the digital assets held by one or more individuals or one or more digital wallets. For example, the voting rights may be adjusted based on the digital assets held by an individual associated with one or more digital wallets. For example, the server computing device 101 may determine that no holder may be allowed to exercise more than five or ten percent of the voting rights (or, alternatively, of the Shapley-Shubik Value) of all eligible or participating parties. The server computing device 101 may add votes to holders of fewer digital assets or reduce votes to holders of more digital assets.

One or more user devices (e.g., admin device 102, user device 103, user device 104, etc.) may be used to access the services of the server computing device 101. The one or more user devices (e.g., admin device 102, user device 103, user device 104, client devices, etc.) may include networked computing devices such as a smart phone, tablet, laptop computer, desktop computer, and the like.

The blockchain system 105 may include one or more processors for processing commands and one or more memories for storing information in one or more blockchain data structures. The blockchain system 105 may be publically assessable (e.g., a distributed decentralized computing system) or may be privately run by a third party entity or the same entity that is running the server computing device 101. The blockchain system 105 maintains one or more blockchains, or distributed ledgers, of continuously growing lists of data blocks, where each data block refers to previous blocks on its lists. The requirement for each block to refer to all previous blocks in the blockchain yields a chain of blocks that is hardened against tampering and revision, such that the information stored the blockchain is immutable. That is, the work required to successfully tamper with or change data in even one block on the blockchain while still maintaining the validity of the blockchain would impose a cost in computing power and time so prohibitively high, that it is not practically possible for even an administrator of the blockchain system 105 to successfully tamper with or change transaction data already in the blockchain.

Transactions may represent the content to be stored in the blockchain. Blocks of transactions may record and confirm when and in what sequence transactions enter and are logged in the blockchain. The blocks may be created from transactions by one or more administrator nodes or, for example, nodes known as “miners” in the blockchain system which use specialized software and/or hardware designed specifically to create blocks. Once a new block is generated that includes a submitted transaction, that transaction becomes a part of the blockchain. The blockchain is then distributed to the various computing nodes that make up the blockchain system. As an example, the blockchain system may comprise the SIMBA blockchain. The SIMBA blockchain may use SIMBA coins as the unit of exchange in transactions, and a specified protocol, or the like, can be used to encode asset transactions in accordance with embodiments described herein. As an example, other blockchain implementations that may be used (e.g., Bitcoin, Chain, Etherium, etc.) do not use SIMBA coins as the unit of exchange in transactions, and can natively encode asset information in the transactions. In blockchain implementations that do not use SIMBA coins as the unit of transaction, for example, a specified protocol can be used to associate metadata with the asset information natively encoded in the transaction.

Server computer device 101 may include, or may connect over a network to, the database 106. The database 106 may include one database or multiple databases at one or more locations, and may store account information, audit information, mappings between blockchain transactions and a means of encoding metadata defining aspects of assets to be recorded in the blockchain and other data. In an example, the database 106 may include one or more external databases or data services. For example, database 106 may include a data service provided by an entity different from the entity controlling the server computing system 101, such as, but not limited to, external data services providing asset information (e.g., securities information), asset ownership information (e.g., share ownership information), voting rights distribution information, user authentication information, etc.

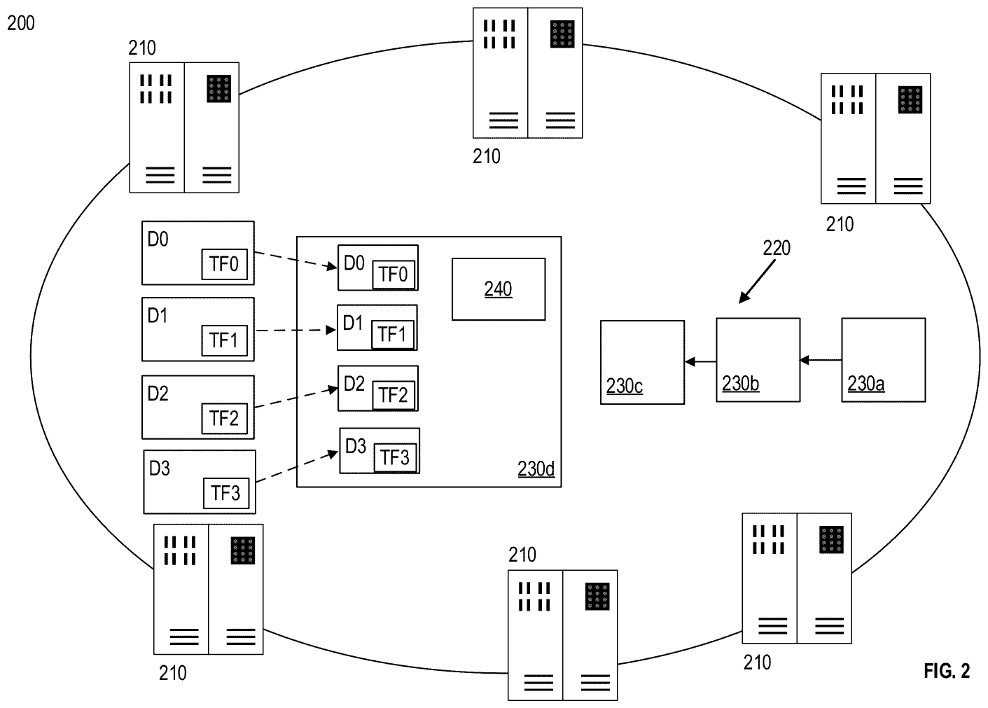

FIG. 2 shows an example blockchain system 150. The blockchain system 150 may comprise a network 200 of nodes 210. Each node 210 may comprise a computing device, a central processing unit, a graphical processing unit, a field programmable gate array, or an application-specific integrated circuit. In an example, each node 210 may comprise a content distribution device, such as a cable modem, set-top box, lap top, smart phone, tablet, wearable computing device, mobile computing device, or any computing device in communication with a content distribution network.

In an example, the network 200 of nodes 210 may comprise a decentralized database. The decentralized database may not have a central administrator or centralized storage. For example, each node 210 in the network 200 may store a copy of a collection of data, such as a distributed ledger. A distributed ledger may comprise a list of recorded entries, such as transactions. The data may be replicated, shared, or synchronized across the nodes 210. The decentralized database may be continually reconciled, such as to reflect changes to the collection of data. The nodes 210 may continually or periodically download the most recent version of the collection of data. When a node 210 joins the network 200, the node 210 may automatically download the collection of data.

A decentralized database, such as a distributed ledger, may comprise a blockchain 220. The decentralized database, such as the distributed ledger, may comprise a blockchain database and/or utilize blockchain data management techniques. A blockchain 220 may comprise one or more blocks 230 in which data is recorded. The blocks 230 in the blockchain 220 may function as a mechanism to organize the data in the blockchain 220. For example, the blocks 230 may be linked in a sequence determined by a relationship of the data in the blocks 230, such as the chronology in which the data is recorded or validated. The blocks 230 may be linked to deter retroactive modification of data in the blockchain 220.

The nodes 210 in the network 200 may build the blockchain 220, such as by adding blocks 230 to the blockchain 220. The nodes 210 may perform several operations to build the blockchain 220. For example, when new data D0, D1, D2, D3 is received by the network 200, the nodes 210 may validate the new data D0, D1, D2, D3. As an example, if the new data D0, D1, D2, D3 comprises transactions, the nodes 210 may validate, verify, or authenticate the identity of the parties to the transaction. A transaction may comprise a public key of a party to the transaction and a digital signature of the party to the transaction. The digital signature may comprise the hash of transaction data, such as with a cryptographic hash function. The digital signature may comprise a hash of transaction data encrypted with a private key corresponding to the public key. Examples of hash functions include MD4, MD5, SHA-1, SHA-256, SHA-512, and SHA-3. The digital signature may be validated by the nodes 210, such as by decrypting the digital signature with the public key. The digital signature may allow for verification of the transaction while maintaining the anonymity of the parties to the transaction.

The nodes 210 may collate the new data D0, D1, D2, D3 into a new block 230d. The nodes 210 may record one data entry DO in a new block 230d. The nodes 210 may perform an operation to add the new block 230d to the blockchain 220. For example, if the data in the blocks 230 is related chronologically, such as where the first block 230a in the blockchain records older data than the data of subsequent blocks 230b, 230c, the nodes 210 may perform a timestamp function to log the sequence in which blocks 230 are added to the blockchain 220. The nodes 210 may append a hash of the previous block 230c to the new block 230d. The nodes 210 may insert an output of the previous block 230 in an input of the new block 230d. The chaining of the blocks, such as through iterative functions, may deter retroactive modification of data in a block 230 as the modification would require new functions to be performed for all of the subsequent blocks 230 in the blockchain 220.

The nodes 210 may be incentivized to perform the operation to add a new block 230d to the blockchain 220. For example, a block 230d may be assigned a value 240, such as a coin or unit of digital currency that will be transferred to one or more nodes 210 that perform part or all of the operation. A digital currency may comprise a cryptocurrency, such as Simbacoin, Bitcoin, Litecoin, TorCoin, Ethereum, etc. The value 240 may depend on the difficulty of performing the operation for the block 230d. Also, if the data D0, D1, D2, D3 recorded in a block 230d comprises transactions, a transaction may assign a transaction fee TF0, TF1, TF2, TF3 which may be transferred to one or more nodes 210 that perform the operation on the block 230d in which the transaction is recorded. If an incentive is provided for nodes 210 to perform the operation to add the new block 230d to the blockchain 220, performance of the operation may be referred to as mining. Mining may comprise creating one or more new units or partial units of the cryptocurrency or other value stored platform and distributing the one or more new units or partial units to the nodes 210 engaged in mining. The one or more new units or partial units of the cryptocurrency or other value stored platform may be created at a predetermined interval. The one or more new units or partial units of the cryptocurrency or other value stored platform may be assigned randomly (e.g., as in a lottery, etc.) to nodes 210 engaged in mining. Cryptocurrency or other value stored platform may be used as a gauge for productive and/or reliability (or proof of stake) among the nodes 210. For example, a validated transaction may not be added to a block 230a, 230b, 230c, 230d if a proof of work (e.g., the computing power used to find a nonce to hash with the block 230a, 230b, 230c, 230d) associated with the transaction is at and/or above a threshold number of digits.

Once the operation is performed to add a new block 230d to the blockchain 220, the nodes 210 may communicate the new block 230d to the network 200. The nodes 210 may express their acceptance of the new block 230d to the blockchain 220 by working off the block 230d when performing the operation to add a subsequent block to the blockchain 220. If more than one version of the blockchain 220 exists, the nodes 210 may attempt to work off the longest blockchain 220. The longest blockchain 220 may be determined by an algorithm for scoring the blockchain 220. For example, a blockchain 220 may be assigned a score based on the computational work required to create the blockchain 220. A node 210 may communicate the longest blockchain 220 that the node 210 has observed to the network 200, such as with a gossip protocol.

The network 200 may have self-correcting mechanisms, such as to address discrepancies between nodes 210 in the network 200. For example, if there is a fork in a blockchain 220, a node 210 working off one branch of the blockchain 220 may switch to a second branch of the blockchain 220, if the second branch becomes longer than the first branch. As an example, if a node 210 does not receive a block 230b, the node 210 may request the block 230b when the node 210 receives the next block 230c and determines that the node 210 did not receive the previous block 230b.

One or more nodes 210 in the network 200 may not participate in building the blockchain 220. The operations that the nodes 210 in the network 200 may perform relating to the blockchain may not be limited to building the blockchain 220. As an example, one or more nodes 210 may monitor the blockchain 220 for particular transactions. For example, the nodes 210 may monitor the blockchain 220 for transactions that comprise an identifier associated with a party.

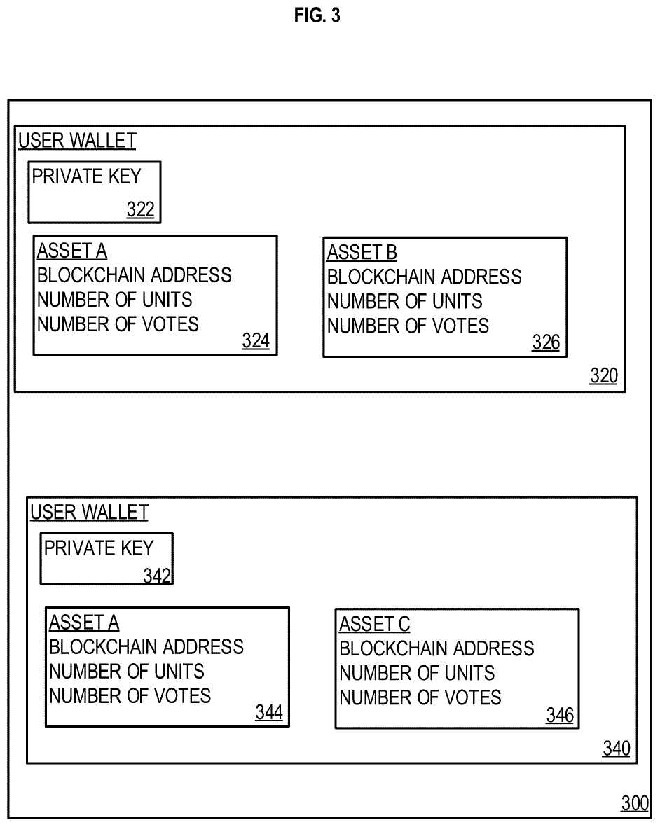

FIG. 3 shows example user wallets that may be stored in the wallet memory 151. The wallet memory 151 may include digital wallets such as user wallet 320 and user wallet 340. A different private key (e.g., 322 and 342), or wallet address, may be recorded in, or may be recorded in association with, each digital wallet. As described above, the private key, or wallet address, may be used in generating the transactions relating to each digital wallet, and may be recorded in the blockchain (e.g., the blockchain in the blockchain system 105).

As shown in FIG. 3, user wallet 320 may include information regarding two assets (e.g., asset A and asset B). A blockchain address and, optionally, a number of units of the asset and a number of votes associated with the number of units of the assets may be recorded for each of asset A (memory area 324) and asset B (memory area 326) in user wallet 320. The number of units information may be determined from the blockchain and, for example, may be stored in, or in association with, the corresponding digital wallet (e.g., in order to reduce the need to access the blockchain for obtaining frequently used information). The number of votes may be associated with the number of digital assets held by the user.

Similarly, user wallet 340 may include information regarding two assets (e.g., asset A and asset C). A blockchain address and, optionally, a number of units of the asset and a number of votes associated with the number of units of the assets may be recorded for each of asset A (memory area 344) and asset C (memory area 346) in user wallet 340. The number of units information may be determined from the blockchain and, for example, may be stored in, or in association with, the corresponding digital wallet (e.g., in order to reduce the need to access the blockchain for obtaining frequently used information). The number of votes may be associated with the number of digital assets held by the user.

As an example, the number of units of the digital asset indicated in the issuer wallet for asset A may have initially been recorded in the blockchain by a transaction as the total number of units of that digital asset. Subsequent transactions may assign units of the digital asset to each owner of digital asset A according to ownership specified in an ownership ledger in the blockchain. For example, each such subsequent transaction may result in adding a number of units of the digital asset to an asset owner's digital wallet according to the ownership specified in the ownership ledger, and may result in deducting that number of units of the digital asset from the issuer's digital wallet.

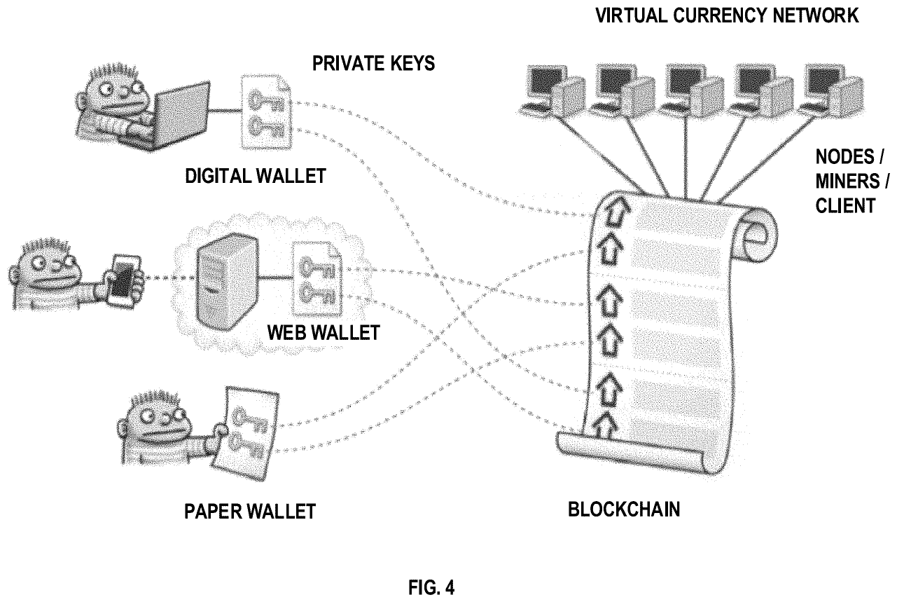

FIG. 4 illustrates an example blockchain network environment in which wallet transactions are recorded in the blockchain. Blockchain currency, or digital currency, may be managed according to an individual's, or user's, digital wallet. Digital wallets let users send or receive virtual currency payments, calculate the total balance of addresses in use, and generate new addresses as needed. Digital wallets may include precautions to keep the private keys secret, for example, by encrypting the wallet data with a password or by requiring two-factor authenticated logins.

Digital wallets may be configured to provide one or more of: storage of digital currency addresses and corresponding public/private keys on the user's computer in a wallet.dat file; an ability to conduct transactions of obtaining and transferring digital currency, also without connection to the Internet, for example; and provide information about the virtual balances in all available addresses, prior transactions, spare keys, etc. Digital wallets may be implemented as stand-alone software applications, web applications, and/or printed documents or memorized passphrases.

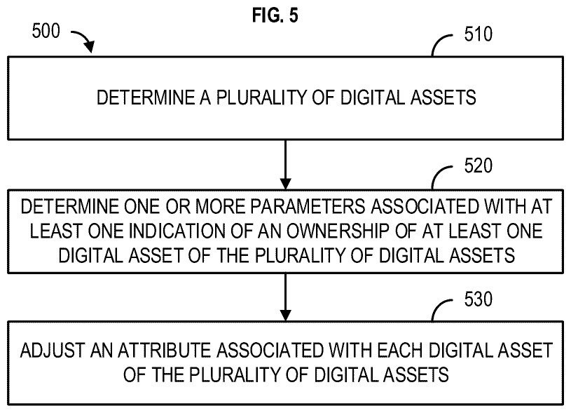

FIG. 5 shows a flowchart of an example method of adjusting an attribute associated with a digital asset. The method may be implemented by one or more user devices (e.g., server computing device 101, admin device 102, user devices 103, 104, or any combination thereof) or can be encoded into a smart contract. In an example, the method may be imposed at the wallet level. At step 510, a plurality of digital assets may be determined. For example, a distribution of the plurality of digital assets may be determined by a user device (e.g., server computing device 101, admin device 102, user devices 103, 104, smart contact associated with a user device, etc.). The digital asset may comprise a cryptocurrency. As an example, an initial distribution of the digital asset may be provided to one or more individuals or one or more digital wallets. Each digital wallet may be associated with a wallet address. The wallet addresses may comprise unique identifiers configured to facilitate the sending and receiving of the digital assets. The initial distribution may be based on a trigger, or event, for releasing the digital asset. The trigger, or event, may comprise at least one of a distribution of the digital asset, a time period before the distribution of the digital asset, a time period after the distribution of the digital asset, or a transaction of the digital asset between two or more digital wallets. A specific number of digital assets may be released, wherein the number of digital asset may depend on the type of activity. For example, the initial distribution of the digital asset may be 30% of the digital asset to the Treasury to be distributed as needed to decentralize the network and incentivize participation. The maximum percentage remaining (up to 70%) that will not cause the chosen decentralization measure to exceed the predetermined limit will be given to the entity performing the distribution of the digital asset. A distribution of digital assets that might cause the centralization measure to exceed the appropriate chosen coefficient may be distributed equally to the digital asset holders that make up the bottom 5% with respect to total holdings. The initial digital asset distribution may be based on a network initiated digital asset minting process, which requires input into the network, in order to initiate a minting request. The minting request may be rolled up daily (at maximum) in order to maintain low resource requirements.

Each digital asset may be given a default voting value, such as an initial voting value of 1 (e.g., one token, one vote). If the algorithm is invoked (e.g., based on a “Simba coefficient” or Gini index), the votes may be reduced from concentrated holders or added to smaller holders, or both, to reduce the coefficient.

At step 520, one or more parameters associated with at least one indication of an ownership of at least one digital asset of the plurality of digital assets may be determined. For example, the one or more parameters associated with at least one indication of an ownership of at least one digital asset of the plurality of digital assets may be determined by the user device (e.g., server computing device 101, admin device 102, user devices 103, 104, smart contact associated with the user device, etc.). The one or more parameters may comprise one or more of a number of digital assets owned or controlled, a period of time for which at least one digital asset of the plurality of digital assets is owned or controlled, an entity from which at least one digital asset of the plurality of digital assets is acquired, a method by which at least one digital asset of the plurality of digital assets is acquired, or a price paid for at least one digital asset of the plurality of digital assets. The entity may comprise one or more of an individual, a person, a governmental entity, a distributor of the digital asset, or a wallet address. In an example, a number of digital assets owned or controlled by an individual, or a digital wallet, may be determined. For example, the at least one indication may comprise one or more of an individual associated with the at least one digital asset of the plurality of digital assets, a person associated with the at least one digital asset of the plurality of digital assets, or a wallet address associated with the at least one digital asset of the plurality of digital assets. In an example, a period of time for which a person, or a digital wallet, owned or controlled at least one digital asset may be determined. In an example, the one or more parameters associated with at least one indication of an ownership of at least one digital asset of the plurality of digital assets may be determined based on at least one of an event, a predetermined time period prior to the event, or a predetermined time period after the event.

As an example, the one or more parameters associated with the at least one indication of the ownership of the at least one digital asset of the plurality of digital assets may be determined based on an event, may be determined prior to an event, or may be determined during an event.

At step 530, an attribute associated with each digital asset of the plurality of digital assets may be adjusted based on the one or more parameters associated with the at least one indication of the ownership of the at least one digital asset of the plurality of digital assets. For example, the attribute associated with each digital asset of the plurality of digital assets may be adjusted by the user device (e.g., server computing device 101, admin device 102, user devices 103, 104, smart contact associated with the user device, etc.) based on the one or more parameters associated with the at least one indication of the ownership of the at least one digital asset of the plurality of digital assets. The attribute may comprise one or more of a voting right, a monetary value, an ability to distribute the digital asset, whitelisting wallet addresses, blacklisting wallet addresses, staking, or combinations thereof.

As an example, voting rights may be adjusted based on a number of digital assets owned or controlled by an individual or digital wallet. In an example, the voting rights may be adjusted based on how long an individual owned or controlled at least one digital assets. In an example, the voting rights may be adjusted based on a price that was paid for at least one digital asset.

As an example, adjusting the attribute associated with each digital asset of the plurality of digital assets may further comprise determining a target parameter. The target parameter may comprise a measure of decentralization comprising one or more of a Gini index, a Nakamoto index, a Shapley-Shubik power index, a Banzhaf power index, or combinations thereof. In addition, the target parameter may be determined based on a total number of digital assets associated with one or more individuals, or digital wallets, and a number of digital assets associated with one or more of a predetermined number of individuals or a predetermined number of digital wallets of the one or more individuals.

As an example, the target parameter may be determined based on a total number of digital assets in distribution and a number of digital assets associated with one or more individuals, or digital wallets, wherein an attribute associated with at least one digital asset of the plurality of digital assets may be adjusted based on the target parameter.

As an example, the target parameter may be determined based on a total number of digital assets associated with one or more wallet addresses and a number of digital assets associated with a specific wallet address of the one or more wallet addresses, wherein an attribute associated with at least one wallet address of the one or more wallet addresses may be adjusted based on the target parameter.

As an example, the target parameter may be determined based on a total number of digital assets associated with one or more individuals associated with one or more wallet addresses and a number of digital assets associated with a specific individual of the one or more individuals, wherein an attribute associated with at least one individual of the one or more individuals may be adjusted based on the target parameter.

As an example, a total number of digital assets associated with one or more entities may be determined. The target parameter may be determined based on the total number of digital assets associated with the one or more entities and a number of digital assets associated with a specific entity of the one or more entities. The attribute associated with at least one digital asset of the plurality of digital assets may be adjusted based on the target parameter.

As an example, a plurality of entities associated with at least one digital asset of the plurality of digital assets may be determined. The target parameter may be determined based on a period of time for which each entity of the plurality of entities is associated with the at least one digital asset of the plurality of digital assets. The attribute associated with at least one digital asset of the plurality of digital assets may be adjusted based on the target parameter.

In an example, the target parameter may be determined based on an entity from which at least one digital asset of the plurality of digital assets is acquired. In an example, the target parameter may be determined based on a method by which at least one digital asset of the plurality of digital assets is acquired. In an example, the target parameter may be determined based on a price paid for at least one digital asset of the plurality of digital assets.

As an example, adjusting the attribute associated with at least one digital asset of the plurality of digital assets may further comprise one or more of adjusting the attribute within each digital asset, adjusting a record associated with each digital asset, adjusting a record associated with at least one wallet address of one or more wallet addresses, increasing the voting rights associated with at least one digital asset, decreasing the voting rights associated with at least one digital asset, or increasing the voting rights associated with a first subset of the plurality of digital assets and decreasing the voting rights associated with a second subset of the plurality of digital assets.

As an example, adjusting the attribute associated with at least one digital asset of the plurality of digital assets may further comprise one or more of increasing the voting rights associated with at least one wallet address, decreasing the voting rights associated with at least one wallet address, or increasing the voting rights associated with a first subset of the one or more wallet addresses and decreasing the voting rights associated with a second subset of the one or more wallet addresses.

As an example, adjusting the parameter associated with at least one digital asset of the plurality of digital assets may further comprise one or more of increasing a voting rights associated with at least one individual associated with one or more wallet addresses, decreasing the voting rights associated with at least one individual associated with one or more wallet addresses, or increasing the voting rights associated with a first subset of individuals associated with one or more wallet addresses and decreasing the voting rights associated with a second subset individuals associated with one or more wallet addresses.

In an example, the attribute associated with each digital asset of the plurality of digital assets may be adjusted periodically. In an example, the attribute associated with each digital asset of the plurality of digital assets may be adjusted prior to an event triggering a release of an additional plurality of digital assets.

In an example, a record may be stored in a blockchain. The record may comprise an indication of a number of digital assets associated with one or more entities. In an example, a registry of one or more entities that are associated with one or more wallet addresses may be stored in a database.

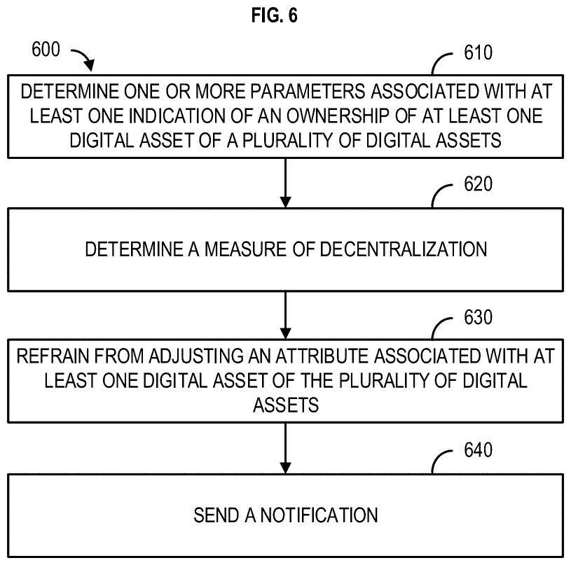

FIG. 6 shows a flowchart of an example method of adjusting an attribute associated with a digital asset. The method may be implemented by the one or more user devices (e.g., server computing device 101, the admin device 102, the user devices 103, 104, or any combination thereof) or can be coded into a smart contract. In an example, the method may be imposed at the wallet level. At step 610, one or more parameters associated with at least one indication of an ownership of at least one digital asset of the plurality of digital assets may be determined based on a trigger. For example, the one or more parameters associated with the at least one indication of the ownership of the at least one digital asset of the plurality of digital assets may be determined by a user device (e.g., server computing device 101, admin device 102, user devices 103, 104, smart contact associated with a user device, etc.) based on the trigger. The one or more parameters may comprise one or more of a number of digital assets owned or controlled, a period of time for which at least one digital asset of the plurality of digital assets is owned or controlled, an entity from which at least one digital asset of the plurality of digital assets is acquired, a method by which at least one digital asset of the plurality of digital assets is acquired, or a price paid for at least one digital asset of the plurality of digital assets. The entity may comprise one or more of an individual, a person, a governmental entity, a distributor of the digital asset, or a wallet address. For example, a number of digital assets owned or controlled by an individual, or a digital wallet, may be determined. In an example, a period of time for which a person, or a digital wallet, owned or controlled at least one digital asset may be determined. The trigger may comprise one or more of an initial distribution of the digital asset, a duration prior to an initial distribution of the digital assets, a duration subsequent to an initial distribution of the digital assets, or a predetermined time interval. The digital asset may comprise a cryptocurrency. The at least one indication of the ownership of the at least one digital as set of the plurality of digital assets may comprise one or more of an individual associated with the at least one digital asset of the plurality of digital assets, a person associated with the at least one digital asset of the plurality of digital assets, or a wallet address associated with the at least one digital asset of the plurality of digital assets.

At step 620, a measure of decentralization may be determined based on the one or more parameters associated with the at least one indication of the ownership of the at least one digital asset of the plurality of digital assets. For example, the measure of decentralization may be determined by the user device (e.g., server computing device 101, admin device 102, user devices 103, 104, smart contact associated with a user device, etc.) based on the one or more parameters associated with the at least one indication of the ownership of the at least one digital asset of the plurality of digital assets. The measure of decentralization may comprise one or more of a Gini index, a Nkamoto index, a Shapley-Shubik power index, a Banhaf power index, or combinations thereof. For example, an algorithm may be used to calculate the Gini coefficient associated with the total number of the plurality of digital assets in distribution and a number of digital assets associated with one or more digital wallets.

At step 630, it may be determined to refrain from adjusting an attribute associated with at least one digital asset of the plurality of digital assets based on the measure of decentralization satisfying a threshold. For example, a user device (e.g., server computing device 101, admin device 102, user devices 103, 104, smart contact associated with a user device, etc.) may determine to refrain from adjusting the attribute associated with the at least one digital asset of the plurality of digital assets based on the measure of decentralization satisfying the threshold. As an example, the measure of decentralization may be used to determine whether or not it is necessary to adjust an attribute associated with at least one digital asset of the plurality of digital assets, wherein the attribute may comprise one or more of a voting right, a monetary value, an ability to distribute the digital asset, whitelisting wallet addresses, blacklisting wallet addresses, staking, or combinations thereof. For example, if the measure of decentralization satisfies a threshold, it may be determined that the attribute does not need to be adjusted. If the measure of decentralization does not satisfy the threshold, it may be determined that the attribute needs to be adjusted. The threshold may comprise a target parameter such as a target Gini coefficient. The attribute may comprise one or more of a voting right, a monetary value, an ability to distribute the digital asset, whitelisting wallet addresses, blacklisting wallet addresses, staking, or combinations thereof.

In an example, the attribute may be adjusted by increasing or decreasing a voting right associated with one or more of at least one digital asset, at least one digital wallet, or at least one individual. In an example, adjusting the attribute may comprise one or more of adjusting the attribute within each digital asset, adjusting a record associated with each digital asset, or adjusting a record associated with at least one wallet address of the one or more wallet addresses.

At step 640, a notification may be sent. For example, the notification may be sent by the user device (e.g., server computing device 101, admin device 102, user devices 103, 104, smart contact associated with a user device, etc.). The notification may comprise an indication of whether the measure of decentralization (e.g., a calculated Gini coefficient), based on the one or more parameters associated with the at least one indication of the ownership of the at least one digital asset of the plurality of digital assets, satisfies the threshold (e.g., the target Gini coefficient).

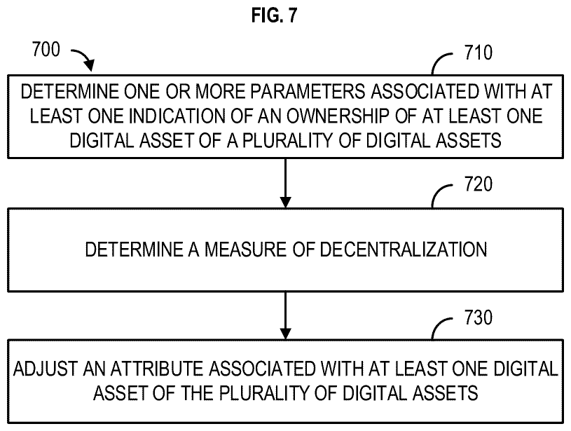

FIG. 7 shows a flowchart of an example method of adjusting an attribute associated with a digital asset. The method may be implemented by one or more user devices (e.g., server computing device 101, admin device 102, user devices 103, 104, or any combination thereof) or can be encoded into a smart contract. In an example, the method may be imposed at the wallet level. At step 710, one or more parameters may be determined based on a trigger. For example, the one or more parameters associated with the at least one indication of the ownership of the at least one digital asset of the plurality of digital assets may be determined by a user device (e.g., server computing device 101, admin device 102, user devices 103, 104, smart contact associated with a user device, etc.) based on the trigger. The one or more parameters may comprise one or more of a number of digital assets owned or controlled, a period of time for which at least one digital asset of the plurality of digital assets is owned or controlled, an entity from which at least one digital as set of the plurality of digital assets is acquired, a method by which at least one digital asset of the plurality of digital assets is acquired, or a price paid for at least one digital asset of the plurality of digital assets. The entity may comprise one or more of an individual, a person, a governmental entity, a distributor of the digital asset, or a wallet address. For example, a number of digital assets owned or controlled by an individual, or a digital wallet, may be determined. In an example, a period of time for which a person, or a digital wallet, owned or controlled at least one digital asset may be determined. The trigger may comprise one or more of an initial distribution of the digital asset, a duration prior to an initial distribution of the digital assets, a duration subsequent to an initial distribution of the digital assets, or a predetermined time interval. The digital asset may comprise a cryptocurrency. The at least one indication of the ownership of the at least one digital asset of the plurality of digital assets may comprise one or more of an individual associated with the at least one digital asset of the plurality of digital assets, a person associated with the at least one digital asset of the plurality of digital assets, or a wallet address associated with the at least one digital asset of the plurality of digital assets.

At step 720, a measure of decentralization may be determined based on the one or more parameters associated with the at least one indication of the ownership of the at least one digital asset of the plurality of digital assets. For example, the measure of decentralization may be determined by the user device (e.g., server computing device 101, admin device 102, user devices 103, 104, smart contact associated with a user device, etc.) based on the one or more parameters associated with the at least one indication of the ownership of the at least one digital asset of the plurality of digital assets. The measure of decentralization may comprise one or more of a Gini index, a Nkamoto index, a Shapley-Shubik power index, a Banhaf power index, or combinations thereof. For example, an algorithm may be used to calculate the Gini coefficient associated with the total number of the plurality of digital assets in distribution and a number of digital assets associated with one or more digital wallets.

At step 730, it may be determined to adjust an attribute associated with at least one digital asset of the plurality of digital assets based on the measure of decentralization not satisfying a threshold. For example, a user device (e.g., server computing device 101, admin device 102, user devices 103, 104, smart contact associated with a user device, etc.) may determine to adjust the attribute associated with the at least one digital asset of the plurality of digital assets based on the measure of decentralization not satisfying the threshold. As an example, the measure of decentralization may be used to determine whether or not it is necessary to adjust an attribute associated with at least one digital asset of the plurality of digital assets, wherein the attribute may comprise one or more of a voting right, a monetary value, an ability to distribute the digital asset, whitelisting wallet addresses, blacklisting wallet addresses, staking, or combinations thereof. For example, if the measure of decentralization satisfies a threshold, it may be determined that the attribute does not need to be adjusted. If the measure of decentralization does not satisfy the threshold, it may be determined that the attribute needs to be adjusted. The threshold may comprise a target parameter such as a target Gini coefficient. The attribute may comprise one or more of a voting right, a monetary value, an ability to distribute the digital asset, whitelisting wallet addresses, blacklisting wallet addresses, staking, or combinations thereof.

As an example, the attribute (e.g., voting rights) may be adjusted based on (e.g., by) one or more of: adjusting the attribute within each digital asset, adjusting a record associated with each digital asset, adjusting a record associated with at least one wallet address of one or more wallet addresses, increasing a voting right associated with the at least one digital asset, decreasing a voting right associated with the at least one digital asset, or increasing a voting right associated with a first subset of the plurality of digital assets and decreasing a voting right associated with a second subset of the plurality of digital assets.

As an example, adjusting the attribute (e.g., voting rights) associated with the digital assets based on a target parameter may involve the use of at least one algorithm of several different algorithms. One family of algorithms may redistribute voting rights among holders in a manner designed to generate a particular Gini coefficient, or to place a maximum or minimum on that coefficient. A Gini coefficient of zero indicates perfect equality in the distribution of voting rights, whereas a coefficient of one indicates that a single entity holds all the voting rights. The Commission's decentralization requirement can be viewed as indicating a maximum Gini coefficient consistent with decentralization. A second family of algorithms may be used to calculate the Shapley-Shubik power index, or other power-metrics, of each participant in the governance process, and reallocate voting rights so as to cause greater equality in the distribution of power as defined by these more advanced metrics. A third family of algorithms could implement basic heuristic rules. For example, no holder may be allowed to exercise more than five or ten percent of the voting rights (or, alternatively, of the Shapley-Shubik Value) of all eligible or participating parties. Alternatively, the rule could, for example, protect the N largest holders from exercising more than X percent of voting rights or power, subject to the further condition that no one holder can exercise more than Y percent of voting rights or power.

In an example, an algorithm based on a desired Gini coefficient, discussed below, may be used to adjust the voting rights pertaining to at least one digital asset. The algorithm first calculates the Gini coefficient for the current digital asset distribution and compares it to the (adjustable) target Gini coefficient. If the current Gini coefficient of the digital asset distribution meets the Gini coefficient requirement, the algorithm terminates. That is, each digital wallet's (or individual associated with one or more digital wallets) voting power is directly proportional to their share of the digital asset. If the current Gini coefficient of the digital asset distribution does not meet the Gini coefficient requirement, then the algorithm computes a vote distribution that will satisfy the Gini coefficient as shown below. Initially each user is assigned the same number of votes as they have digital assets. Then the algorithm computes the new distribution by solving the following constrained optimization problem. For example, the solution to this optimization problem essentially produces a floor for a number of votes a digital wallet has. That is, it assigns all of the digital wallets holding the smallest percentages of the distribution of the digital asset the same number votes as the calculated floor, and it leaves the rest of the digital wallets' vote assignments untouched.

The following provides a detailed description of the Voting Weight Assignment Algorithm:

A distribution of tokens may be issued across a population of users where tokens entitle users to governance rights. If the Gini index of this token distribution is above a specified target value, the algorithm described here will assign a number of votes to each user so that the resulting (vote) distribution has a Gini index equal to the target Gini index. Initially, each user is assigned the same number of votes as they have tokens. The algorithm then computes the new distribution by solving the constrained optimization problem outlined below. This algorithm does not address measures of centralization other than the Gini index.

For example, suppose there are n users. The variable vᵢ is used to denote the number of votes assigned to user i (that is, initially it represents the number of tokens user i possesses). Also, it is assumed that the vote shares are arranged in ascending order so that v₁ represents the fewest votes held by any user and v n represents the most votes held by any user. That is:

v₁≤v₂≤v₃≤ . . . ≤vᵢ≤vᵢ₊₁≤ . . . ≤vₙ−1≤vₙ

Also, since the algorithm will add votes to the system to hit the target level of decentralization, the variable aᵢ is used to denote the number of votes added to user i (note this value could be 0) during the algorithm. The objective is to minimize a₁+a₂+ . . . +aₙ (the total number of votes added to the system). Doing so requires several conditions to be met. The first is that inversions are not permitted. That is, if User A has fewer tokens than User B, then in the new vote distribution, User B will have at least as much voting power as User A. Second, the new distribution requires a Gini index equal to

$$\frac{p}{q} ,$$

which may be referred to as the target Gini index. This value is input into the algorithm.

A solution to this problem is the values of a₁, a₂, . . . , aₙ which satisfy the constraints. The solution to this optimization problem produces a floor for the number of votes a user may have. That is, it assigns all of the “poorest” users (users 1, 2, . . . , k) to have the same number of votes as the calculated floor, and it leaves the rest of the users' (users k+1, k+2, . . . , n) vote totals equal to their token holdings. The number of votes to be added, and the number of voters for which to add the number of votes, is determined by the given distribution.

Before determining the Gini index algorithm, it is necessary to discuss the constrained optimization problem that the algorithm is used to solve. The objective is to minimize, subject to a list of constraints: (1) minimize the number of votes added to the distribution; and (2) subject to the constraints consisting of ascending vote totals, prohibited inversions, and the Gini index of the new distribution equaling the target Gini index input into the algorithm. The formulas for each of these conditions are discussed below. The generic formula to calculate the Gini index for a distribution x₁, x₂, . . . , xₙ is

$$g = \frac{{\sum }_{i = 1}^{n} {\sum }_{j = 1}^{n} \vert {x}_{j} - {x}_{i} \vert}{2 {n}^{2} \overline{x}}$$

wherein x̅ is the mean of all the xᵢ. Since the distribution will be ordered with x₁≤x₂≤ . . . ≤xₙ, it can be simplified as

$$g = \frac{{\sum }_{i = 1}^{n} {\sum }_{j = 1}^{n} \vert {x}_{j} - {x}_{i} \vert}{2 {n}^{2} \overline{x} ( {\sum }_{i = 1}^{n} {x}_{i} ) / n} = \frac{{\sum }_{i = 1}^{n} {\sum }_{j = 1}^{n} \vert {x}_{j} - {x}_{i} \vert}{2 n ( {\sum }_{i = 1}^{n} {x}_{i} )} = \frac{{\sum }_{i = 1}^{n} {\sum }_{j = 1}^{n} \vert {x}_{j} - {x}_{i} \vert}{n ( {\sum }_{i = 1}^{n} {x}_{i} )}$$

The term xᵢ appears in this sum exactly n−1 times, paired once with each other term x₁, x₂, . . . , xᵢ₋₁ and xᵢ₊₁, . . . , xₙ. The distribution is ordered and the pairs xⱼ-xᵢ in the sum are all written with the greater term and index first (and therefore added), and the lesser term and index second (subtracted). This means when the appearances of the term xᵢ are considered, it will be greater than x₁, x₂, . . . , xᵢ₋₁ and thus, for each of the i−1 appearances the term is added. In all other appearances, with the terms xᵢ₊₁, . . . , xₙ, it will be the smaller term, and thus, will be subtracted. Overall, xᵢ is added i−1 times in this sum and subtracted n−i times. The coefficient on this term is therefore (i−1)−(n−i)=(i−1−n+i)=(2i−n−1).

Therefore, the equivalence is determined:

Σᵢ₌₁ⁿΣⱼ₌ᵢⁿ(xⱼ−xᵢ)=Σⱼ₌₁ⁿ(2j−n−1)xⱼ

Based on the equivalence, the following formula may be determined

$$g = \frac{{\sum }_{j = 1}^{n} ( 2 j - n - 1 ) {x}_{j}}{n ( {\sum }_{j = 1}^{n} {x}_{j} )}$$

The variable g may now be replaced with

$$\frac{p}{q} ,$$

which is used to represent me target Gini index:

$$\frac{p}{q} = \frac{{\sum }_{j = 1}^{n} ( 2 j - n - 1 ) {x}_{j}}{n ( {\sum }_{j = 1}^{n} {x}_{j} )}$$

This equation may be further simplified by clearing the denominator

pn(Σⱼ₌₁ⁿxⱼ)=q(Σⱼ₌₁ⁿ(2j−n−1)xⱼ)

By setting the formula to zero and combining, the following may be determined:

$$\begin{matrix}0 = ( pn {\sum }_{j = 1}^{n} {x}_{j} - q {\sum }_{j = 1}^{n} ( 2 j - n - 1 ) {x}_{j} ) = {\sum }_{j = 1}^{n} ( pn - q ( 2 j - n - 1 ) ) {x}_{j} \\ = {\sum }_{j = 1}^{n} ( pn - q ( 2 j - n - 1 ) ) ( {x}_{j} ) = {\sum }_{j = 1}^{n} ( n ( p + q ) - q ( 2 j - 1 ) ) ( {x}_{j} ) ,\end{matrix}$$

$$or {\sum }_{j = 1}^{n} ( q ( 2 j - 1 ) - n ( p + q ) ) ( {x}_{j} ) = 0$$

The distribution may be further defined such that xᵢ=vᵢ+aᵢ, and thus, resulting in the following formula (Gini constraint):

Σⱼ₌₁ⁿ(q(2j−1)−n(p+q))(vⱼ+aⱼ)=0

This last form of the Gini constraint will be used directly in the algorithm. Note that aₙ will always equal zero (user(s) that already hold the most votes will never be given more votes).

With the determination of the Gini constraint, the following algorithm may be used to solve the constrained optimization problem. There are four parts in the algorithm (parts A, B, C, and D). Rather than solving directly for each value of aᵢ, the algorithm produces the final distribution in the incomes array. This is equivalent to solving for each aᵢ in the original problem statement, since for any user, the amount that was added to their original vote total is the difference between their vote totals in the two distributions (the final and the original).

The algorithm builds this final distribution by updating the incomes array in each pass of the loop. The incomes array initially contains the values of vᵢ from the original problem statement. The values in incomes are progressively modified as the algorithm proceeds, so the first pass incomes differs from the original distribution. Note that while the distribution in incomes is not the same as the original distribution, each pass works from that new distribution. In particular, in the equations, vᵢ is used to represent the value in incomes[i]. In each pass of the loop the number of votes that needs to be added to the first i users is solved in order to satisfy the Gini constraint. This is represented as aᵢ in the equations, and that value is based on the current distribution in incomes.

Part A: Initializing

The divisor is set to zero so that it can be used to contain the sum of the first i coefficients. The incomes array is initialized to contain the initial totals v₁, v₂, . . . , vₙ. The coefficients array contains the coefficients on v₁, v₂, . . . , vₙ directly computed from the left-hand side of the Gini constraint, cᵢ=q(2i−1)−n(q+p).

Part B: Calculate the Number of Votes Users 1 to i would Need to be Given in Order to Satisfy the Gini Constraint

In the algorithm at each step, a test is used to determine whether the target Gini index can be achieved by adding votes to only the first i users (while still satisfying the inversion constraint). In Part B, the number of votes, x=aᵢ, is calculated that would need to be added to these users on top of the current distribution to satisfy the Gini constraint. Next, it is determined whether the calculated amount would satisfy the inversion constraint (in the if-statement).

Note that it might or might not be impossible to add votes only to these first i users and satisfy both the Gini constraint and the inversion constraint between users i and i+1. Parts (C) and (D) handle the actions to be taken depending on whether the value of x manages to satisfy all of these constraints.

For this part of the loop in the algorithm, incomes[1]=incomes[2]= . . . =incomes[i] from the updates in part (D) during the previous pass. That is, v₁=v₂= . . . =vᵢ. Since all of the first i users have the same number of votes, that same number of votes will be added to each of them, so in this step a₁=a₂= . . . =aᵢ. No votes will be added to any other users, so aᵢ₊₁=a₁₊₂= . . . =aₙ=0. Also entering this part of the loop, the value of the divisor is coef f [1]+ . . . +coef f [i−1] from the previous pass. The first line in part (B) updates the divisor to include coef f [i] so it is the sum of the first i coefficients.

To solve for how many votes each of the first i users totals would need to increase by, the equivalences above are substituted into the Gini constraint and solved for aᵢ.

Based on the above Gini constraints formula, q(2j−1)−n(q+p) is replaced with cⱼ=coef f [j].

Σⱼ₌₁ⁿcⱼ(vⱼ+aⱼ)=0

Separating into two sums results in the following:

Σⱼ₌₁ⁿcⱼaⱼ=−Σⱼ₌₁ⁿcⱼvⱼ

Using aᵢ₊₁= . . . =aₙ=0 results in the following:

Σⱼ₌₁ⁱcⱼaⱼ=−Σⱼ₌₁ⁿcⱼvⱼ

Using (in this pass of the loop) vⱼ=vᵢ and aⱼ=aᵢ for all j<i, the formula may be reduced to

Σⱼ₌₁ⁱcⱼaᵢ=−Σⱼ₌₁ⁿcⱼvⱼ

Factoring out aᵢ and solving for aᵢ results in the following:

$${a}_{i} = \frac{- {\sum }_{j = 1}^{n} {c}_{j} {v}_{j}}{{\sum }_{j = 1}^{n} {c}_{j}} = \frac{- total}{{\sum }_{j = 1}^{n} coef f [ j ]} = \frac{- total}{divisor} = x$$

In the algorithm, coef f [j]=cⱼ and incomes[j]=vⱼ so the numerator is negative the sum of the terms coef f [j] *income[j], which is the variable total. The denominator in this formula is exactly the value of divisor from the algorithm, since divisor is the sum of the first i coefficients. Thus, the value calculated for aᵢ is the same value calculated by the algorithm as x. This value represents the number of additional votes that would need to be added to each of the users 1 through i for the distribution to meet the target Gini index. As a side note, in the next section, it will be shown that x is always positive.

This value found for x satisfies the Gini constraint by design, but it may or may not satisfy the inversion constraint, particularly from i to i+1. The if-statement that ends Part (B) tests whether the calculated amount x would satisfy the inversion constraint: vᵢ+aᵢ≤vᵢ₊₁+aᵢ₊₁. With aᵢ₊₁=0, this can be rewritten as aᵢ≤vᵢ₊₁−vᵢ. At this point, vᵢ₊₁=coef f [i+1] and vᵢ=coef f [i]. Part (C) handles the remainder of the algorithm if the inversion constraint does hold with this value of x. Part (D) handles updating to a new distribution if the inversion constraint does not hold and prepares us to start the next iteration of the algorithm.

Part C: If x Satisfies the Inversion Constraint

Part (C) is only entered if the inversion constraint is satisfied by this value of x. In this case, the for-loop adds the x votes to users 1 to i. Then the break statement is executed to exit the outer loop, which ends the algorithm. At the end of this part, the incomes array contains the final distribution with incomes[i]=vᵢ+aᵢ from the original problem. This gives the solution to the problem. Note that by definition the Gini constraint is met and the inversion constraints are all satisfied.

Part D: If x does not Satisfy the Inversion Constraint

Part (D) is entered if the value of x does not satisfy the inversion constraint, which means it is not possible to add enough votes to only users 0 to i to both attain the target Gini index and still satisfy the inversion constraint (specifically between user i and i+1). To address this, the distribution is updated by adding the maximum number of votes allowed by the inversion constraint. That is, the vote totals are set for users 1 to i equal to the vote total of user i+1.

At the end of Part (D) all users 1 to i+1 now have the same number of votes assigned to them, and this number was insufficient to reach the target Gini index (otherwise the algorithm would have ended by executing Part (C). The next step will be to increment i and execute Part (B) in the next pass of the outer loop. In this new updated distribution the Gini constraint is not yet met, but all other constraints, by design, still hold.

The following is an example of the algorithm written in pseudo-code:

```
(* Part A: Initialize *)
divisor = 0
For i = 1 to n begin
  incomes [i] = v[i]
  coeffs [i] = q * (2 * i − 1) − n * (q + p)
end
For i = 1 to n − 1 begin
  (* Part B: Calculate x *)
  divisor = divisor + coeffs [i] = 0
  total = 0
  For j = 1 to n begin
    total = total + coeff [j] * incomes [j]
  end
  x = −1 * total / divisor
  If x <= incomes [i + 1] − incomes [i]
  begin
    (* Part C: If x satisfies constraints *)
    For j = 1 to i begin
      incomes [j] = incomes [j] + x
    end
    break
  end
  (* Part D: If x does not satisfy constraints *)
  For k = 1 to i begin
    incomes [k] = incomes [i + 1]
  end
end
```

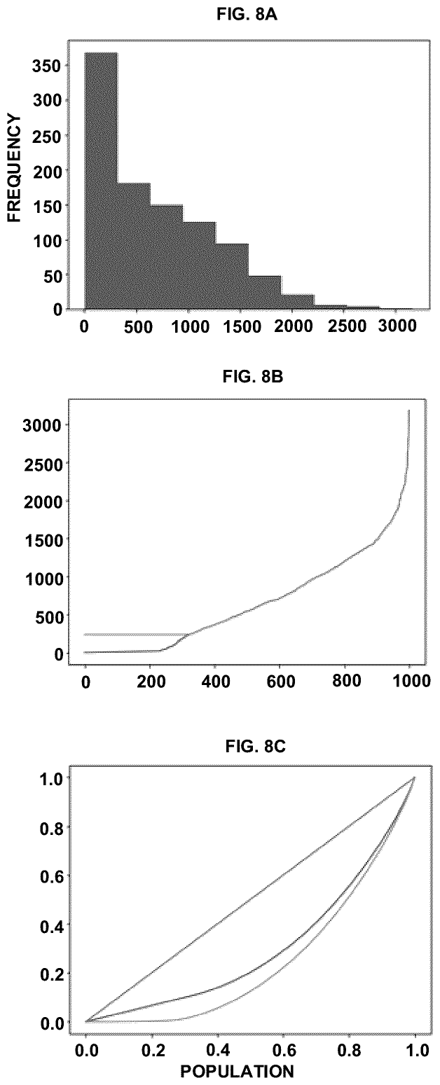

FIGS. 8A-8B show example results of the distribution of voting rights associated with the distribution of a digital asset associated with a blockchain. FIG. 8A shows the initial distributions of the digital asset, wherein the amount of tokens released decreases for each distribution event of the digital asset. FIG. 8B shows a representation of a vote distribution associated with an initial distribution of the digital asset. Each user is listed out in order (to 1000 users) and the number of digital assets is plotted. By comparing the two plotted curves, it is shown that the poorest users, around the first 300 users all have their votes raised to the same level, the calculated floor. As an example, a Gini goal of 0.4 was initially set. The initial voting rights distribution of the digital asset did not meet the Gini requirement, but the new distribution has a Gini index of exactly 0.4.

FIG. 8C shows a Lorenz curve which is another way of viewing the distribution of wealth. As an example, the population is placed in ascending order of wealth. The X-axis of a Lorenz curve represents the percentile of the population of an individual and the Y-axis represents the percentage of the total wealth (from the entire population) that the individuals up to that percentile own between them. For example, if the poorest 60% of the population together held 10% of the total wealth, then the Lorenz curve would pass through (0.6, 0.1). If the wealth were distributed perfectly, where every individual had the same amount of wealth, the Lorenz curve would follow the straight line, as shown in FIG. 8C. FIG. 8C further shows the initial wealth distribution. The “interior line” shows the wealth distribution after the adjustment, wherein it is closer to the perfect straight line. That is, the wealth distribution has improved. This will always be the case with the present algorithm.

As an example, the methods of 500, 600, and 700 may be repeated at predetermined intervals, or on a periodic basis, to constantly check the distribution of voting rights, and essentially the levels of decentralization. For example, the method may check the distribution of the digital asset held by each individual every hour, day, or week and subsequently determine adjust the voting rights associated with at least one digital asset accordingly. In an example, a new digital asset mint event may cause a new distribution of digital assets amongst digital wallets. The method may determine the new distribution of the digital assets associated with each digital wallet. Subsequently, a new target parameter, or Gini index, associated with the distribution of the digital asset may be determined and the voting rights may be adjusted accordingly.

The distinct benefit of this innovation as applied in the context of crypto-instruments that are potentially subject to SEC regulation is that it allows instruments to become decentralized very rapidly, including possibly even at the time of launch. It also allows decentralization to be achieved without the use of airdrops or other mechanisms that raise separate and distinct legal issues, and that may not effectively achieve the desired result.

While the precise application of these principles is illustrated and applied in the context of crypto-instruments, the innovation can also be more generally applied to all situations in which governance rights are allocated across a population of stockholders in order to magnify or reduce the voting rights associated with particular holders' positions.

As a separate observation, it is possible to estimate the distribution of Bitcoin and Ether across digital wallets at the time of the Hinman speech. From that information, it is possible to compute the Gini coefficient, Shapley-Shubik values, and other metrics that summarize the power and voting distributions of Bitcoin and Ether at that time. The Hinman speech concluded that Bitcoin and Ether were not securities because, among other reasons, they were sufficiently decentralized. A decentralization algorithm that generates decentralization metrics at least as favorable as those observed among Bitcoin and Ether holders at that time should therefore support the conclusion that the instruments at issue are not securities under federal law. This observation creates a quantitative basis upon which to compute maximum levels of concentration of voting or governance rights that removes much of the speculation currently dominant in the market.

Each of the constitutional elements described in the present document may consist of one or more components, and names thereof may vary depending on a type of an electronic device. The electronic device according to various exemplary embodiments may include at least one of the constitutional elements described in the present document. Some of the constitutional elements may be omitted, or additional other constitutional elements may be further included. Further, some of the constitutional elements of the electronic device according to various exemplary embodiments may be combined and constructed as one entity, so as to equally perform functions of corresponding constitutional elements before combination.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
determining, by a computing device, a plurality of digital assets;
determining one or more parameters associated with at least one indication of an ownership of at least one digital asset of the plurality of digital assets; and
adjusting, based on the one or more parameters associated with the at least one indication of the ownership of the at least one digital asset of the plurality of digital assets, an attribute associated with each digital asset of the plurality of digital assets.

2. The method of claim 1, wherein the digital asset comprises a cryptocurrency.

3. The method of claim 1, wherein the one or more parameters comprise one or more of: a number of digital assets owned or controlled, a period of time for which at least one digital asset of the plurality of digital assets is owned or controlled, an entity from which at least one digital asset of the plurality of digital assets is acquired, a method by which at least one digital asset of the plurality of digital assets is acquired, or a price paid for at least one digital asset of the plurality of digital assets.

4. The method of claim 1, wherein the at least one indication of the ownership of the at least one digital asset of the plurality of digital assets comprises one or more of: an individual associated with the at least one digital asset of the plurality of digital assets, a person associated with the at least one digital asset of the plurality of digital assets, or a wallet address associated with the at least one digital asset of the plurality of digital assets.

5. The method of claim 1, wherein the attribute comprises one or more of: a voting right, a monetary value, an ability to distribute the digital asset, whitelisting wallet addresses, blacklisting wallet addresses, staking, or combinations thereof.

6. The method of claim 1, further comprising adjusting the attribute associated with each digital asset of the plurality of digital assets based on a measure of decentralization comprising one or more of a Gini index, a Nakamoto index, a Shapley-Shubik power index, a Banzhaf power index, or combinations thereof.

7. The method of claim 1, wherein adjusting the attribute associated with each digital asset of the plurality of digital assets comprises one or more of:
adjusting the attribute within each digital asset;
adjusting a record associated with each digital asset;
adjusting a record associated with at least one wallet address of one or more wallet addresses;
increasing a voting right associated with at least one digital asset;
decreasing a voting right associated with at least one digital asset; or
increasing a voting right associated with a first subset of the plurality of digital assets and decreasing a voting right associated with a second subset of the plurality of digital assets.

8. The method of claim 1, further comprising:
storing a record in a blockchain, wherein the record comprises an indication of a number of digital assets associated with one or more entities; and
storing, in a database, a registry of one or more entities that are associated with one or more wallet addresses.

9. A method comprising:
determining, by a computing device, based on a trigger, one or more parameters associated with at least one indication of an ownership of at least one digital asset of a plurality of digital assets;
determining, based on the one or more parameters associated with the at least one indication of the ownership of the at least one digital asset of the plurality of digital assets, a measure of decentralization;
refraining from adjusting, based on the measure of decentralization satisfying a threshold, an attribute associated with at least one digital asset of the plurality of digital assets; and
sending a notification comprising an indication of the measure of decentralization satisfying the threshold.

10. The method of claim 9, wherein the trigger comprises one or more of: an initial distribution of the plurality of digital assets, a duration prior to an initial distribution of the plurality of digital assets, a duration subsequent to an initial distribution of the plurality of digital assets, or a predetermined time interval.

11. The method of claim 9, wherein the digital asset is a cryptocurrency.

12. The method of claim 9, wherein the one or more parameters comprises one or more of: a number of digital assets owned or controlled, a period of time for which at least one digital asset of the plurality of digital assets is owned or controlled, an entity from which at least one digital asset of the plurality of digital assets is acquired, a method by which at least one digital asset of the plurality of digital assets is acquired, or a price paid for at least one digital asset of the plurality of digital assets.

13. The method of claim 9, wherein the at least one indication of the ownership of the at least one digital asset of the plurality of digital assets comprises one or more of: an individual associated with the at least one digital asset of the plurality of digital assets, a person associated with the at least one digital asset of the plurality of digital assets, or a wallet address associated with the at least one digital asset of the plurality of digital assets.

14. The method of claim 9, wherein the measure of decentralization comprises one of more of: a Gini index, a Nkamoto index, a Shapley-Shubik power index, a Banzhaf power index, or combinations thereof.

15. The method of claim 9, wherein the attribute comprises one or more of: a voting right, a monetary value, an ability to distribute the digital asset, whitelisting wallet addresses, blacklisting wallet addresses, staking, or combinations thereof.

16. A method comprising:
determining, by a computing device, based on a trigger, one or more parameters associated with at least one indication of an ownership of at least one digital asset of a plurality of digital assets;
determining, based on the one or more parameters associated with the at least one indication of the ownership of the at least one digital asset of the plurality of digital assets, a measure of decentralization; and
adjusting, based on the measure of decentralization not satisfying a threshold, an attribute associated with at least one digital asset of the plurality of digital assets.

17. The method of claim 16, wherein the trigger comprises one or more of: an initial distribution of the plurality of digital assets, a duration prior to an initial distribution of the plurality of digital assets, a duration subsequent to an initial distribution of the plurality of digital assets, or a predetermined time interval.

18. The method of claim 16, wherein the digital asset is a cryptocurrency.

19. The method of claim 16, wherein the one or more parameters comprises one or more of: a number of digital assets owned or controlled, a period of time for which at least one digital asset of the plurality of digital assets is owned or controlled, an entity from which at least one digital asset of the plurality of digital assets is acquired, a method by which at least one digital asset of the plurality of digital assets is acquired, or a price paid for at least one digital asset of the plurality of digital assets.

20. The method of claim 16, wherein the at least one indication of the ownership of the at least one digital asset of the plurality of digital assets comprises one or more of: an individual associated with the at least one digital asset of the plurality of digital assets, a person associated with the at least one digital asset of the plurality of digital assets, or a wallet address associated with the at least one digital asset of the plurality of digital assets.

21. The method of claim 16, wherein the measure of decentralization comprises one of more of: a Gini index, a Nkamoto index, a Shapley-Shubik power index, a Banzhaf power index, or combinations thereof.

22. The method of claim 16, wherein the attribute comprises one or more of: a voting right, a monetary value, an ability to distribute the digital asset, whitelisting wallet addresses, blacklisting wallet addresses, staking, or combinations thereof.

23. The method of claim 16, wherein adjusting, based on the measure of decentralization not satisfying the threshold, the attribute associated with the at least one digital asset of the plurality of digital assets comprises one or more of:
adjusting the attribute within each digital asset;
adjusting a record associated with each digital asset;
adjusting a record associated with at least one wallet address of one or more wallet addresses;
increasing a voting right associated with the at least one digital asset;
decreasing a voting right associated with the at least one digital asset; or
increasing a voting right associated with a first subset of the plurality of digital assets and decreasing a voting right associated with a second subset of the plurality of digital assets.
